(19) United States
(12) Patent Application Publication
(10) Pub. No.: US 2002/0128985 A1
(43) Pub. Date: Sep. 12, 2002

(54) Vehicle value appraisal system

(76) Inventor: Brad Greenwald, Nanuet, NY (US)

Correspondence Address: KENNETH J HOVET LAW OFFICES, 4476 MARKET ST, SUITE 601, VENTURA, CA, 93003, US

(21) Appl. No.: 09/954,127

(22) Filed: Sep. 18, 2001

Related U.S. Application Data
(60) Provisional application No. 60/274,683, filed on Mar. 9, 2001.

(51) Int. Cl. G06G 7/00

(52) U.S. Cl. 705/400

(57) ABSTRACT

A vehicle appraisal system in accordance with the present invention includes a processor, a reference databank of published values for different makes and models of vehicles and an enclosure having diagnostic tools for determining and recording the mechanical condition of the vehicle. The vehicle is positioned within the enclosure and data concerning the interior condition of the vehicle alignment, undercarriage, engine, interior and body are recorded by the diagnostic equipment within the enclosure. The processor accesses the reference databank for a baseline value for the vehicle under consideration. The processor then receives this data collected from inspection of the vehicle and access a plurality of discrete databanks containing repair data to determine the cost of repairing the vehicle. The processor then adjust the baseline value by the repair cost of the vehicle according to a predetermined algorithm to yield an appraisal value for the vehicle.

This application claims priority from Application Serial No. 60/274,683, which was filed Mar. 9, 2001.

### FIELD OF THE INVENTION

The present invention pertains generally to appraisal systems. More specifically, the present invention pertains to systems for appraising vehicles from a remote location. The present invention is particularly useful as a system for appraising a vehicle that arranges the appraisal data in a format which is easily accessible via the internet or other electronic media.

### BACKGROUND OF THE INVENTION

Every year millions of used cars are bought by consumers and/or dealers. The used cars are bought either from other consumers or from other used car dealers/wholesalers. Before purchase, however, an initial determination of the worth of the car must be accomplished by the buyer. To do this, a consumer will look up a published (commonly known as “blue book”) value of the car to determine approximately how much a car of a particular make and model is worth.

The published value of a car, however, is merely a rough estimate that is based on a comparison of a plurality of many cars of similar make and model. As such, the published value is only an approximation and is not necessarily an optimum price for the specific vehicle under consideration. The actual value of the specific vehicle is sometimes higher than, but usually lower than, the published value for the vehicle once representative factors such as the condition of the engine, the transmission, the vehicle body and the interior are considered. Accordingly, to obtain an optimum price, the buyer must adjust the published value that corresponds to the value of the vehicle under consideration according to the actual mechanical condition of the vehicle.

In order to adjust the published value as discussed above, the buyer usually must physically see the vehicle to determine the condition of the vehicle body and the vehicle interior. The consumer must physically inspect the engine and associated machinery to determine the mechanical condition of the engine. Based on these inputs, the consumer/must then generates an informal adjustment value for each vehicle item inspected and then adjusts the published value according to the generated adjustment value(s) for the specific vehicle under consideration.

The above method, however, has two main drawbacks. First, the consumer/dealer must be physically present in the vicinity of the car in order to inspect the vehicle and generate the above value adjustments. Second, unless the consumer/dealer is familiar with the exact aspect of the vehicle (bodywork, interior, engine, transmission, etc.) being inspected, the consumer/dealer may generate a adjustment value which is inaccurate. This would further result in an inaccurate appraisal value of the specific vehicle under consideration.

As an additional consideration, with the emergence of the internet as a viable shopping medium, many buyers now do their shopping via the internet, intranet or other electronic medium. Heretofore, using the internet to shop for a used car has been a difficult and risky proposition because the buyer has been unable to determine the actual condition of the vehicle. Since the buyer could not determine the actual condition of the vehicle, the buyer could not adjust the published value of the car to determine the actual value of the vehicle.

U.S. Pat. Ser. No. 5,781,871, which issued to Mezger et al for an invention entitled “Method of Determining Diagnostic Threshold Values For A Particular Motor Vehicle Type And Electronic Computing Unit For A Motor Vehicle, discloses a system with an external computer that is connected to an electronic computing unit of a vehicle. Mechanical data from the vehicle is transmitted to the external computer and then to a central computer for storage. Mezger et al, however, does not discloses any manner of generating a value for the transmission, nor does it discloses any manner of video and/or sound equipment for determining the condition of the vehicle interior and exterior. Further, the central computer disclosed by Mezger does not contain an algorithm for manipulating the received data in order a monetary value corresponding to the specific vehicle under consideration.

U.S. Pat. Ser. No. 4,128,005, which issued to Arnston et al for an invention entitled “Automated Engine Component Diagnostic Techniques”, discloses a system and method for automatic diagnosis of an automobile engine. U.S. Pat. Ser. No. 3,683,683, which issued to Demidov et al for an invention entitle “Automatic Diagnostic Station For Automobiles”, similarly discloses a system and method for automatic diagnosis of automobile engines. Neither reference, however, discloses a processor or method for manipulating the engine diagnostic data for adjusting the published value of the vehicle according the results of the automatic diagnosis of the automobile engine.

In light of the above, it is an object of the present invention to provide an appraisal system for vehicle that clearly and accurately portrays a specific used vehicle for the internet or other electronic media. It is another object of the present invention to provide a system and method that evaluates the overall material condition of the specific vehicle and adjusts a published value according to the actual condition of the specific vehicle under consideration. Another object of the present invention is to provide an appraisal system and method for generating an accurate appraisal for a specific vehicle for a consumer/dealer without requiring the consumer/dealer to be physically located in the vicinity of the vehicle. It is another object of the present invention to provide a system and method for determining what repairs are required and the cost for accomplishing the required repair actions on a specific vehicle. An additional object of the present invention is to provide a system and method for vehicle appraisal that is relatively simple to use, is easy to manufacture and is cost effective.

### SUMMARY OF THE INVENTION

A vehicle appraisal system in accordance with the present invention includes a processor, a databank of values for similar vehicles and a plurality of diagnostic equipment for determining the mechanical condition of the vehicle. The mechanical diagnostic equipment is installed within an enclosure which is large enough to receive the vehicle therein. The processor and databank are also in the enclosure, although the processor and databanks could also be placed at a location remote from the enclosure.

The diagnostic equipment includes an overhead camera, a floor camera and a telescoping stand. The overhead camera is movably attached to a guide track in the ceiling for taking a panoramic picture of the vehicle from above. The telescoping stand is connected to a track in the enclosure floor, and the floor camera is attached to the free end of the telescoping stand. The overhead camera and floor cameras are preferably digital cameras to facilitate transmission of visual data concerning condition of the vehicle body and vehicle to the processor.

The diagnostic equipment includes a plurality of rollers and an alignment console. The rollers are recessed in the enclosure floor and determine the camber of the vehicle wheels and the alignment of the vehicle chassis. The rollers send this information concerning camber and alignment to an alignment console that is located in the enclosure. The alignment console further transmits the alignment and camber data to the processor.

An engine analyzer and microphone are arranged within the enclosure for diagnosing the condition of the engine. The microphone record the sound of the engine while operating, and the engine analyzer determines the mechanical condition of the engine. The microphone and engine analyzer send their data to the processor via a engine diagnostic console, which is located in the enclosure.

The enclosure of the present invention further includes a hydraulic lift that is reciprocatingly mounted within the enclosure floor in a manner well known in the prior art. When the vehicle is resting on the hydraulic lift, the lift is selectively operated to raise the vehicle to a spaced-apart position from the floor. This allows the floor camera to visually record the condition of the vehicle undercarriage and to send the undercarriage data to the processor.

Initially, the processor accesses a reference databank to obtain an initial published value that corresponds to the vehicle under consideration. Next, the processor receives data from each of the above components as described above. For each component, the processor accesses a databank to generate an adjustment factor corresponding to the data received by the processor. For example, the processor receives bodywork data (for example, a dent on a rear bumper) and accesses the bodywork databank to determine the cost of repair/replacement for a bumper corresponding to the vehicle under consideration.

Similarly, an alignment factor, an undercarriage factor, an engine factor and an interior factor are generated. The processor adjusts the published value of the value of the vehicle by each factor mentioned above to yield a appraised value for the vehicle. The processor is further connected to a internet website or other electronic media so that end-users (both auto vendors and consumers) can access the appraised value of the vehicle, as well as access the raw data for the vehicle, from a remote location.

The enclosure can be a garage-type structure having a rolling carriage (like a drive-thru carwash, for example). An alternative embodiment of the invention is envisioned wherein the vehicle rests on a platform/on the ground and the diagnostic equipment is enclosed within a briefcase-sized object. Yet another embodiment includes a remote virtual reality enclosure which the end-user operates. The virtual reality enclosure give the end-user the perception that the end-user is actually in the enclosure where the vehicle is located and is physically inspecting the vehicle.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a general schematic diagram of the system of the present invention.

FIG. 2 is a top plan view of the interior of the enclosure for the system of FIG. 1.

FIG. 3 is a perspective view of the enclosure of FIG. 2.

FIG. 4 is the same view as FIG. 3 but with a vehicle located within the enclosure and with the hydraulic lift extended.

FIG. 5 is a block diagram of the processor for the system of FIG. 1

FIG. 6 is a diagram of an alternative embodiment of the system of FIG. 1

FIG. 7 is a diagram of another alternative embodiment of the system of FIG. 1

### WRITTEN DESCRIPTION OF THE PREFERRED EMBODIMENTS

Referring to the Figures, the appraisal system of the present invention is shown and is generally designated by reference character 10. In brief overview, the system includes an enclosure 12. A vehicle 14 is positioned within enclosure 12, and the overall condition of the vehicle is evaluated in a manner to be described. In the preferred embodiment, the system appraises the value of used cars. It is to be appreciated, however, that the system and method of the present invention can be used to appraise other complex machines, such as trucks, airplanes, boats (drydocked), motorcycles and the like, as long as the machine is placed within the enclosure for appraisal.

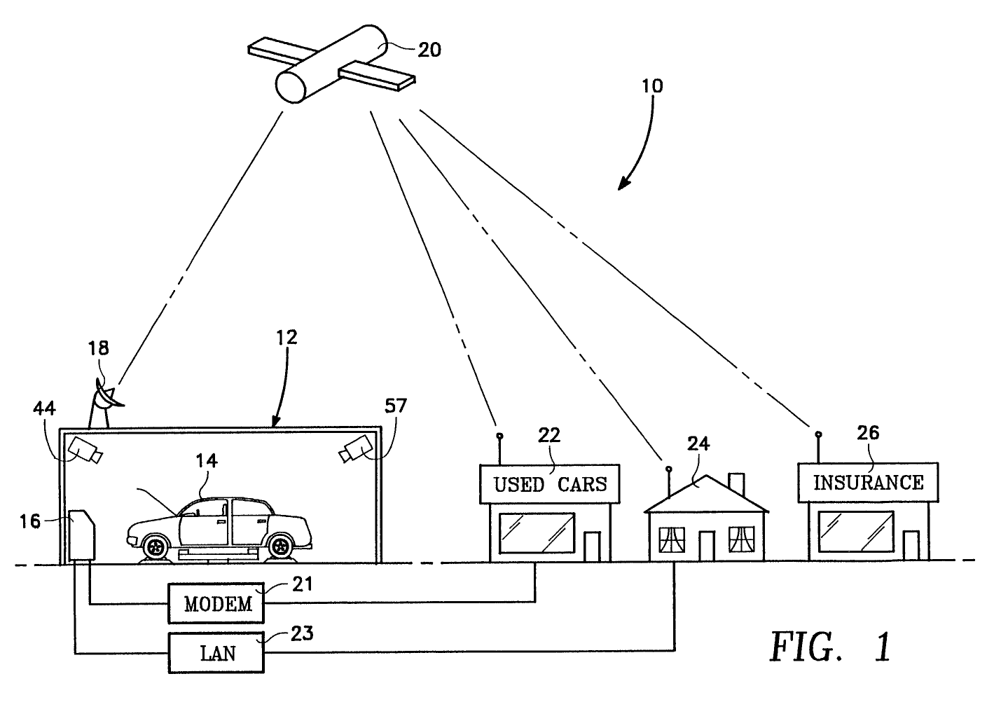

A processor 16 receives data generated by examination of the vehicle. As indicated in FIG. 1, the processor can be, but does not necessarily have to be, located within enclosure 12. The processor is connected to a transmitter 18 which transmits output data from the processor via a satellite 20 to a remote user station such as a used car dealership 22, a private residence 24, or an insurance adjustment facility 26. It is to be understood that any means of data transmission currently known in the art is appropriate for the transmission of output data, such as a telephone modem line or Local Area Network (LAN) line, for example, as depicted by respective boxes 21 and 23 in FIG. 1.

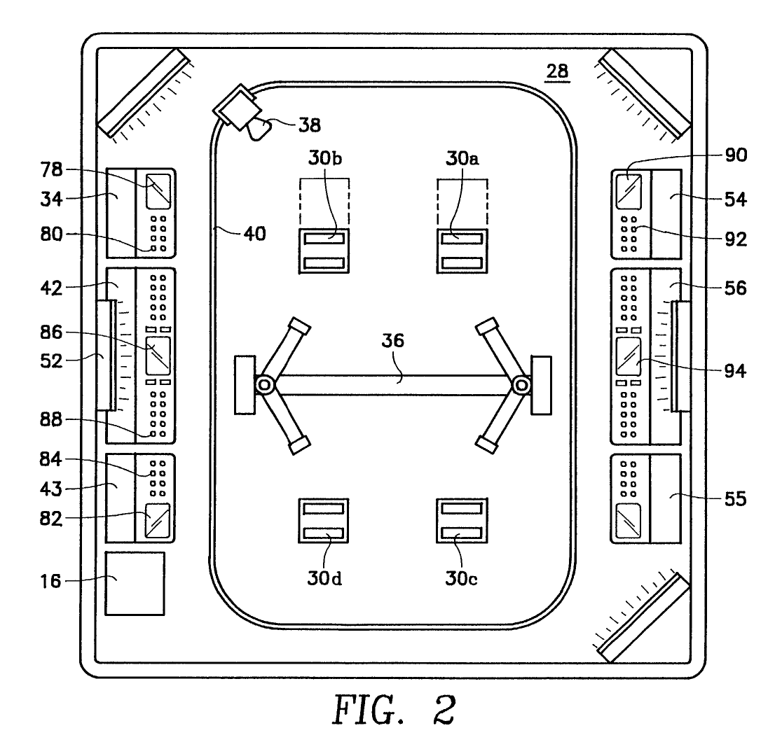

Referring primarily now to FIGS. 2-4, the enclosure is shown in greater detail. More specifically, the bottom floor 28 of the enclosure includes a plurality of rollers 30a-d (best seen in FIG. 2). When vehicle 14 is parked within the enclosure, each wheel 32 for the vehicle rests upon a respective roller 30. During operation, the rollers allow for rotation of the wheels while the vehicle remains stationary within the enclosure. The rollers mounted within the floor so that they can tilt transversely with respect to the vehicle. With this configuration, the rollers can determine the camber of each wheel, as well as determine whether the wheels are in alignment.

The rollers are connected to an alignment console 34, which receives data on the camber of each wheel and alignment of the wheel(s). Alignment console 34 allows for local display and evaluation of alignment data via an alignment display 78, as well as for local manipulation of the rollers via alignment console controls 80. Alignment console 34 is also connected to processor 16 for further transmission of the camber and alignment data to the processor.

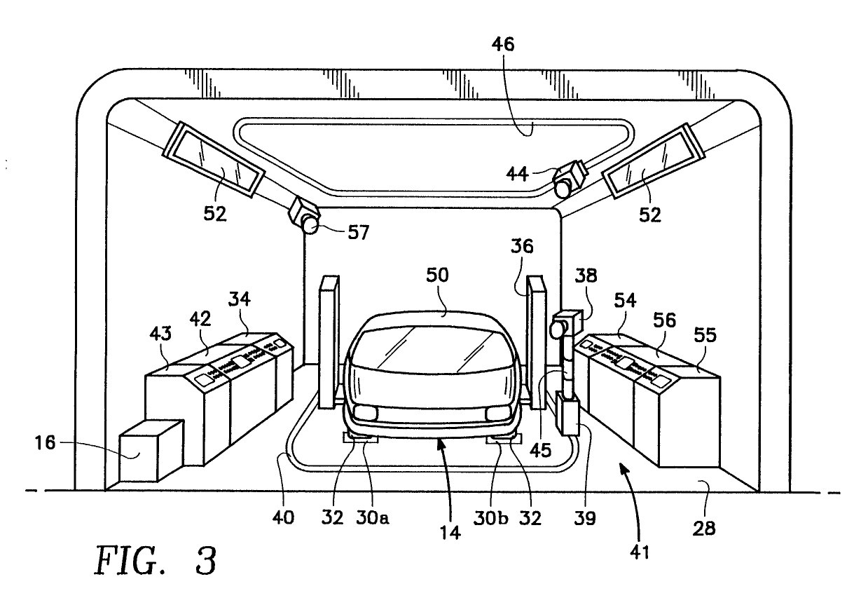

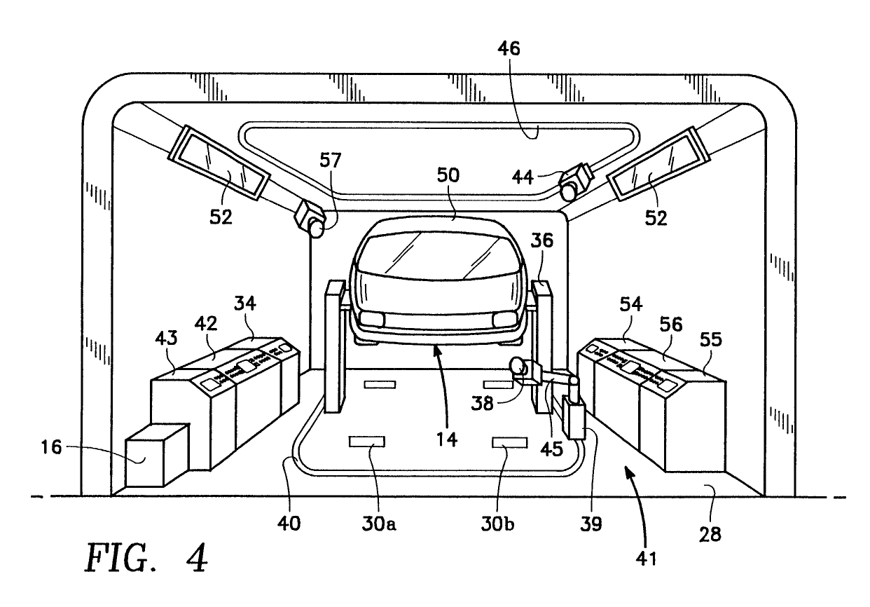

As best seen in FIGS. 3 and 4, a floor camera 38 is tiltably mounted to a telescoping stand 39. Telescoping stand 39 is slidably mounted along floor track 40. When telescoping stand 39 is in a fully extended position (as depicted in FIG. 3), floor camera 38 is raised until it is above the window level of the vehicle. Once at this level, floor camera 38 is tilted downwardly and is focused into the vehicle interior (not shown), and telescoping stand 39 is moved around floor track 40.

As telescoping stand 39 moves around floor track 40, floor camera 38 visually records vehicle interior data, such as cuts, rips and tears in the vehicle upholstery (not shown), and transmits this interior data to an interior console 43. In similar fashion to alignment console 34, interior console 43 includes an interior console display 82 and interior console controls 84 for local evaluation of the interior data and manipulation of the floor camera, respectively. Interior console 43 is connected to processor 16 for further transmission of the vehicle interior data to the processor.

To allow for inspection of the vehicle undercarriage, the system of the present invention includes a hydraulic lift 36 that is also movably positioned within enclosure 12 in order to vertically raise and/or lower the vehicle within the enclosure. This allows for inspection of the undercarriage (not shown) of the vehicle, as described below.

With vehicle 14 positioned on hydraulic lift 36, hydraulic lift 36 is extended to lift vehicle 14 in a spaced-apart position above floor 28. With vehicle 14 spaced-apart from floor 28, telescoping stand 39 is retracted until floor camera 38 is below the undercarriage, as shown in FIG. 3. Next, middle portion 45 of telescoping stand 39 is adjusted to position floor camera 38 under the vehicle, and floor camera 39 is tilted upward and focused on the vehicle undercarriage to conduct the undercarriage inspection.

As telescoping stand 38 moves around floor track 40, the floor camera records visual data concerning the mechanical condition of the vehicle undercarriage. Examples of the sort of undercarriage data obtained include the presence/absence of holes and/or rust in the exhaust system, integrity of the constant velocity (CV) boot(s), and the like. The floor camera relays the recorded data to an undercarriage console 42. In similar fashion to the interior console 43 and alignment console 34, the undercarriage console 42 includes an undercarriage console display 86 and undercarriage console controls 88 for local evaluation of undercarriage data and manipulation of the floor camera 38, respectively. Also, undercarriage console 42 is further connected to processor 16 for transmission of undercarriage data thereto.

As shown in FIGS. 3 and 4, overhead camera 44 is slidably mounted on a ceiling track 46 which is proximate the perimeter of enclosure ceiling 48 is focused onto the top portion of the vehicle body. As the overhead camera moves along ceiling track 46, overhead camera 44 records the visual appearance and material condition of the vehicle body 50. More specifically, the overhead camera records any visual imperfection in the overhead portion of body exterior, such as dents, scratches, windshields cracks and the like. Overhead camera 44 is connected to body console 54 and transmits the collected body data to body console 54.

Floor camera 38 can be used in cooperation with overhead camera 44 to record the condition of the vehicle body. To do this, floor camera 38 is re-focused from the vehicle interior to the side portions of the vehicle body, and telescoping stand 39 is moved around the vehicle as described above. In addition to the interior console, floor camera is also connected to body console 54. Body console 54 includes a body console display 90 for local display of the body data for the vehicle. Body console 54 also includes body console controls 92 for manual manipulation of the floor camera 38 and overhead camera 44. Body console 54 is connected to processor 16 for further transmission of received body data to the processor.

For both the overhead camera 44 and the floor camera 38, a plurality of lighting devices 52 (See FIG. 3) are arranged within the enclosure in a manner which provides optimum lighting conditions for recording the above-described undercarriage data, interior data, and body data for the vehicle.

The appraisal system of the present invention includes an automated engine diagnostic tool 55 (See FIGS. 2-4) for determining the mechanical condition of the engine. Such diagnostic tools are well known in the prior art and measure such engine parameters as engine oil pressure, engine emissions, coolant inlet and outlet temperature and engine timing parameters. One example of such a diagnostic tool is disclosed by U.S. Pat. Ser. No. 4,128,005 which issued to Arnston et al. for an invention entitled “Automated Engine Component Diagnostic Techniques” and which is incorporated herein by reference.

Engine diagnostic tool 55 is connected to engine console 56 for transmitting measurements from engine diagnostic tool 55 to engine console 56. In order to record the sound of the vehicle during operation a microphone 57 is also provided in enclosure 12, as shown in FIGS. 3-4. Microphone 57 provides an audio indication when the engine for vehicle 14 is operating, and further provides an additional input to engine console 56. Engine console 56 includes an engine console display 94 for local display/evaluation of the engine data and engine console controls 96 for manual control of engine diagnostic tool 55.

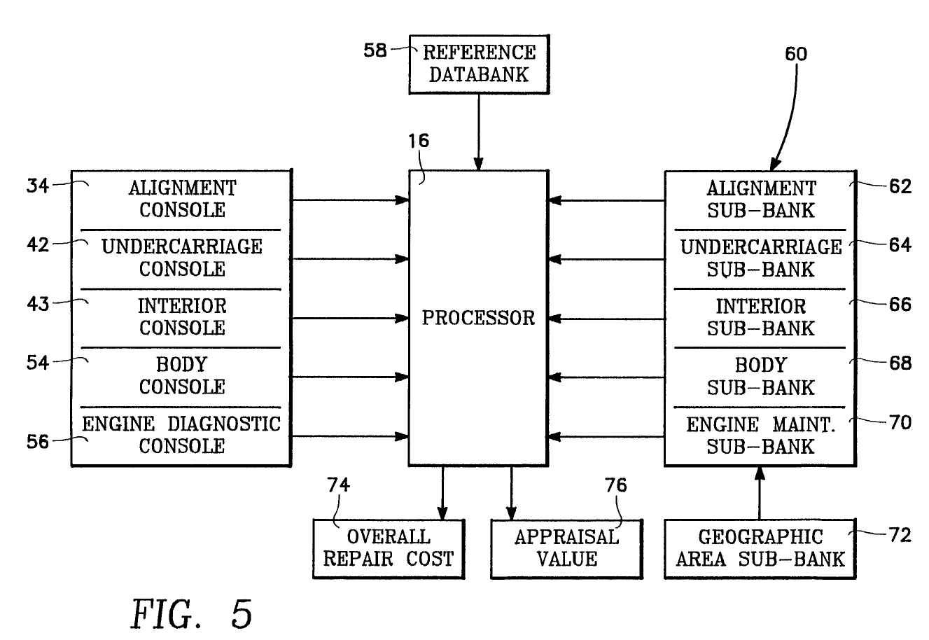

Heretofore, the manner in which the data concerning the specific vehicle under evaluation is collected has been described. Referring primarily now to FIG. 5, the manner in which the generated data is used by processor 16 is more fully described. As depicted in FIG. 5, alignment console 34 inputs data concerning wheel alignment, camber and tread depth into processor 16. Similarly, undercarriage console 42, interior console 43, body console 54 and engine diagnostic console 56 also input data into processor 16 concerning the undercarriage, interior, body and engine, respectively.

Processor 16 is also connected to a reference databank 58 for selective access thereof. Reference databank 58 contains a plurality of reference values a wide range of makes and models of used vehicles. An exemplary data bank would be the data bank of vehicle values as published in the Kelley Blue Book®.

Processor 16 also is connected maintenance databank 60 for selective access of maintenance data. Maintenance databank 60 contains data concerning the cost of different types of possible repairs for different types of vehicles. Maintenance databank 60 can be further divided into sub-banks such as alignment maintenance sub-bank 62, undercarriage maintenance sub-bank 64, interior maintenance sub-bank 66, bodywork maintenance sub-bank 68 and engine maintenance sub-banks 70. Each of these respective sub-banks corresponds to a particular mechanical are of the vehicle and contains data concerning the costs of different repairs actions in that mechanical area. Each sub-bank can further be divided further. For example, alignment sub-bank 62 can be further divided into alignment geographic bank 72, if desired. Alignment geographic bank 72 would contain data on the cost of a repair action for an alignment problem in a given geographic location.

After the mechanical condition of vehicle 14 is evaluated as described above, processor 16 accesses reference databank 58 for a published value corresponding to the vehicle being appraised. Processor 16 then manipulates the received inputs from consoles 34, 42, 43, 54 and 56 (as a result of the inspection), and sub-banks, 62, 64, 66, 68, 70, and 72 to yield an overall repair cost for the vehicle, according to a predetermined algorithm. The overall repair cost for the vehicle is depicted by box 74. Processor 16 then adjusts the published value for the vehicle by an adjustment factor, the overall repair cost depicted by box 74, to yield an appraisal value for the vehicle, depicted by box 76.

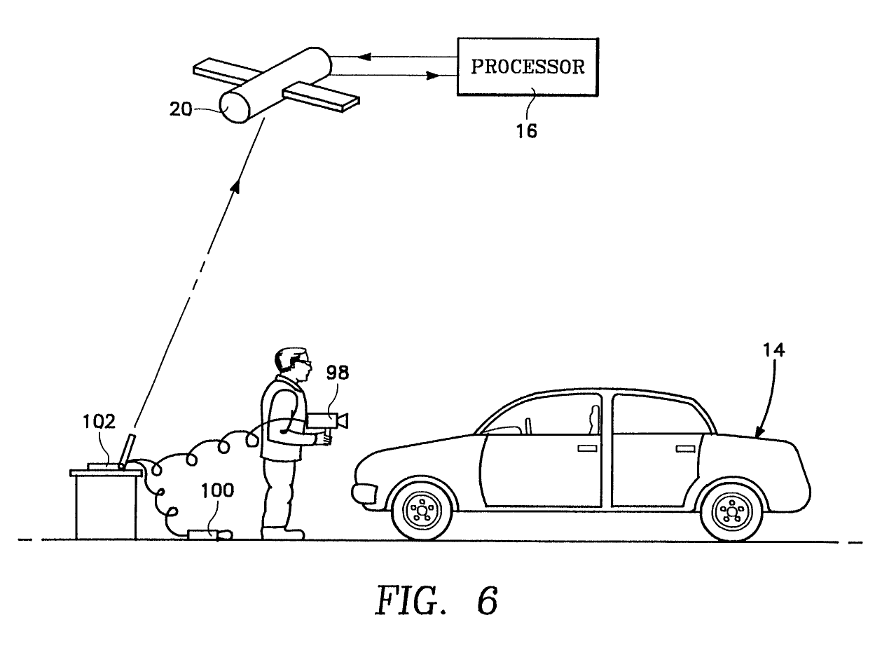

Referring now to FIG. 6, an alternative portable embodiment for the system of the present invention is shown. This embodiment includes a hand-held camera 98 for recording the interior condition of the vehicle and for recording the condition of the vehicle body. A hand-held microphone 100 can be used to record the sound of the vehicle when the vehicle engine is operating. The handheld camera 98 and handheld microphone 100 are connected to a portable console 102 (preferably a laptop computer) and transmit data thereto.

Portable console 102 is in communication with a remote processor 16 via satellite or by any other prior art method available, as discussed above. Processor 16 receives the transmitted body data, interior data and the engine sound data. Processor 16 (which is located remote to portable console 102) selectively accesses reference databank 58, interior sub-bank and body sub-bank as discussed above to generate the appraisal price of the vehicle based on the actual condition of the interior and body of the vehicle as discussed above. As also discussed above, the appraisal price can be further accessed by a dealership 22, private residence 24 or insurance adjustment facility 26 (See FIG. 6).

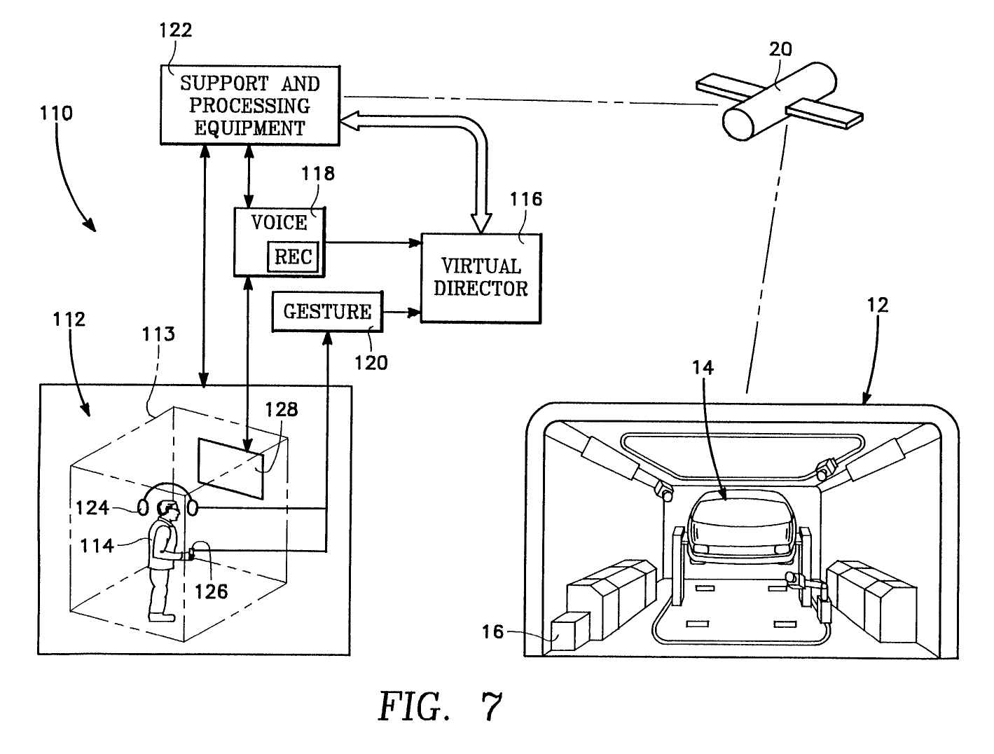

Referring now to FIG. 7, yet another alternative embodiment of the present invention is shown. Broadly, this embodiment of the present invention is a three dimensional data structure system with virtual reality interface as discussed below. Through the interface, an operator may fully interact with and perform operations on a data structure (In this case, enclosure 12) which presented in three dimensions in the virtual environment. With this configuration, a virtual reality effect can be accomplished wherein it appears as though operator 114 (See FIG. 7) were actually within enclosure 12, instead of at a remote location.

As shown in FIG. 7, the virtual reality system 110 includes an environment 112 which preferably immerses an operator 114 in a three dimensional virtual reality enclosure 113. Data presented to operator 114 in environment 112 may be created or operated upon through a virtual director 116. Input to the virtual director 116 is through voice recognition subsystem 118, and through manipulation of a spatial tracker 120, which allows six degree of freedom manipulation. Support processing and equipment, depicted by block 122 in FIG. 7, will include libraries, computations, stereo user glasses and display subsystems (not shown in FIG. 7). The nature of the support processing and equipment will depend upon the environment 112, and different environments may be used in the present system 110. The basic requirement of a suitable environment is acceptance of textual inputs to enable its performance functions and its display manipulation functions.

The preferred embodiment of the invention uses a CAVE™ immersion environment 112. The CAVE™ environment is a multi-person-sized room containing high-resolution three dimensional video and audio equipment (not shown) that is located within environment 112. The video and audio equipment “projects” enclosure 12 onto the environment walls and floor. To do this, real-time computer graphics are rear-screen projected in stereo onto three walls, and front projected onto the floor of the environment 112. Preferably, the computer graphics are projected with a Silicon Graphics Onyx system with Reality Engines™ for each wall and floor. The net effect of the above-described structure is to convert an image of enclosure 12 into a virtual enclosure 113, wherein operator 114 has the perception of being physically located within enclosure 12 and inspecting vehicle 14.

Operator 114 wears stereo glasses (not shown) to view images in virtual enclosure 113 three dimensions. A head tracking device 124 is affixed the stereo glasses that are worn by the operator. As the head tracker moves, stereo projection and convergence from the operator's perspective is constantly updated by support and processing equipment 122. In addition to head tracker 124, the virtual system 110 of the present invention employs a spatially tracked wand 126 to allow for free form navigation in all directions through the six degree of freedom motion.

With the virtual reality system 110 of the present invention, operator 114 navigates easily and accurately through virtual enclosure 113 within environment 112. A detailed menu system with a command line input structure also accepts voice commands and appears to operator 114 as a window 128 within the virtual enclosure 113. Since the preferred CAVE™ environment is a multi-person environment, other users in the immersion environment 112 that are wearing stereo glasses see the virtual enclosure 113 through the perspective of operator 114.

Support and processing equipment 122 is connected to processor 16 and includes a software library (also preferably made by CAVE™) for interaction with processor 16. This allows for operator to selectively manipulate alignment console alignment console 34, undercarriage console 42, interior console 43, body console 54 and engine console 56 during operation of the virtual reality system 110.

The manufacture immersion environment and operation thereof is described in greater detail in U.S. Pat. Ser. No. 6,154,723, which issued to Cox et al. for an invention entitled “Virtual Reality 3D Interface System for Data Creation, Viewing And Editing” and which is incorporated herein by reference.

### OPERATION

### Enclosure Embodiment

During operation, processor 16 first retrieves a baseline value from reference databank 58. Next, processor 16 receives data from alignment console 34. If the data retrieved from alignment console 34 is within a predetermined range of values, the baseline value for the vehicle is not adjusted. If, however, the data from the alignment console reveals that the vehicle under consideration requires a wheel alignment, then the processor retrieves data from alignment maintenance sub-bank 62. More specifically, processor retrieves data from alignment maintenance sub-bank concerning the cost of a wheel alignment for the particular make and model of vehicle according the geographic area where the vehicle is physically located (block 72 in FIG. 5). The processor then adjusts the value of the vehicle according to the retrieved data.

In similar fashion, processor sequentially retrieves data from the undercarriage console 42, interior console 43, body console 54, and engine diagnostic console 56. For all received data, the processor compares the data to a predetermined value. If the received data is outside of the range of acceptable values, the processor accesses the corresponding maintenance sub-bank to determine the dollar value of fixing vehicle 14 and adjusts the baseline value from reference databank 58 accordingly.

The final product of the process is a list of material defects, if any, of the vehicle, and an overall cost estimate as to what is required to fix the defects (Represented by block 74 in FIG. 5), and a recommended appraisal price denoted by block 76 in FIG. 5 for the specific vehicle. The system also uses the visual and audio outputs of the floor camera 38 and overhead camera 44 and transmits this data via transmission line 76 as described above. This provides the additional option to end-users such as car dealerships 22, private homes 24 or insurance adjustment facilities 26 (See FIG. 1) to view the actual data for themselves, if desired.

### Handheld Embodiment

For operation of this embodiment, processor 16 first retrieves a baseline value from reference databank 58. Next, processor 16 receives data from portable console 102, as recorded by hand-held camera 98 and hand-held microphone 100. If the data retrieved from portable console 102 is within a predetermined range of values for the interior and body of the vehicle, the baseline value for the vehicle is not adjusted. If, however, the data from portable console reveals that the vehicle under consideration requires interior and/or body work, then the processor retrieves data from interior sub-bank 66 and/or body sub-bank 68. More specifically, processor retrieves data from interior sub-bank 66 and/or body sub-bank 68 concerning the cost of interior and body work for the particular make and model of vehicle according the geographic area where the vehicle is physically located (block 72 in FIG. 5). The processor then adjusts the value of the vehicle according to the retrieved data.

The final product of the process is a list of material defects, if any, for the vehicle interior and body, and an overall cost estimate as to what is required to fix the defects (Represented by block 74 in FIG. 5), and a recommended appraisal price denoted by block 76 in FIG. 5 for the specific vehicle. This embodiment of the system also uses the visual and audio outputs of the hand-held camera 98 and hand-held camera 100 and transmits this data via transmission line 76 as described above. This provides the additional option to end-users such as car dealerships 22, private homes 24 or insurance adjustment facilities 26 (See FIG. 1) to view the actual data concerning the vehicle body and interior, if desired.

### Virtual Director (Virtual Reality) Embodiment

For operation of the virtual director, operator 114 generates voice commands and/or head movements in conjunction with hand gestures (with the hand that is holding wand 126). The voice commands and head movements/hand gestures are translated by the voice recognition subsystem 118 and spatial tracker 120, respectively, and input into virtual director 116. Virtual director 116 transmits these commands to support and processing equipment 122.

Support and processing equipment 122 transmits the commands to processor 16 within enclosure 12 via satellite 20 (or any convenient broadcast means such as telephone modem line or a Local Area Network (LAN) line. Processor receives the commands and interacts with alignment console 34 to determine the camber of the wheels for vehicle 14 and alignment for the vehicle chassis as described above. The process is repeated for the undercarriage console 42, interior console 43, body console 54 and engine console 56 to display data concerning the vehicle undercarriage, interior, body and engine to operator 114 in environment 112.

Recommended appraisal value 76 from processor 16 is also transmitted to environment 112 for display in window 128. In this manner, operator 114 is able to determine the mechanical condition of a remotely-located vehicle in a virtual reality environment.

For all of the above-described embodiments, in addition to manipulating the vehicle inspection data in a manner which allows for an accurate appraisal of a specific vehicle, the data is arranged in a manner which allows for estimating the cost to repair a vehicle. Accordingly, the system of the present invention is useful for insurance companies as a system for appraisal a specific vehicle (or the cost to fix a specific vehicle from a remote location).

While the vehicle valuation system, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A system for determining an appraisal value of a machine comprising:
a processor;
a reference databank containing a plurality of published values for similar versions of said machine; and,
means for diagnosing the mechanical condition of said machine, said diagnosing means generating an adjustment factor according to said mechanical condition and sending said adjustment factor to said processor, said processor selectively accessing said databank and combining one of said plurality and said adjustment factor according to a predetermined algorithm to yield said appraisal value for said machine.

2. The system of claim 1 further comprising an enclosure for receiving said machine, said diagnosing means being mounted within said enclosure.

3. The system of claim 1 further comprising:
a transmitter connected to said processor for receiving said appraisal value; and,
a broadcast media in communication with said transmitter for receiving said appraisal value from said transmitter for further transmission to a plurality of users.

4. The system of claim 2 wherein said enclosure has a floor and wherein said diagnosing means further comprises:
a telescoping stand having a floor end and a camera end, said floor end being being movably mounted to said floor to allow for movement of said stand completely around said machine when said machine is within said enclosure; and,
a floor camera mounted to said camera end and connected to said processor for transmitting interior images of said machine to said processor.

5. The system of claim 4 further comprising an overhead camera movably attached to said ceiling for taking body images of said machine, said overhead camera being connected to said processor for sending said body images to said processor.

6. The system of claim 2 wherein said machine has an engine and further wherein said diagnostic means further comprises:
an engine analyzer mounted within said enclosure and connected to said processor; and,
a microphone mounted within said enclosure and connected to said processor, said engine analyzer and said microphone, in combination, transmitting engine data to said processor when said engine is operating.

7. The system of claim 2 wherein said machine has a plurality of wheels and further comprising:
a plurality of rollers recessed in said floor for determining camber and alignment of said wheels, each of said wheels resting on a corresponding roller when said machine is within said enclosure; and,
each of said rollers being connected to said processor for transmitting alignment data on a corresponding wheel to said processor.

8. The system of claim 4 wherein said machine has an undercarriage and further comprising:
a hydraulic lift reciprocatingly mounted in said floor for selectively raising said machine to a spaced-apart position above said floor when said machine is resting on said lift; and,
said floor camera transmitting undercarriage images to said processor when said machine is in said spaced-apart position.

9. The system of claim 5 wherein said adjustment factor includes an interior factor and further comprising:
an interior databank connected to said processor, said processor selectively accessing said alignment databank for an interior value corresponding to said machine and combining said interior value and said interior images according to said predetermined algorithm to yield said interior factor.

10. The system of claim 5 wherein said adjustment factor includes a bodywork factor and further comprising:
an bodywork databank connected to said processor, said processor selectively accessing said bodywork databank for a bodywork value corresponding to said machine and combining said bodywork value and said body images according to said predetermined algorithm to yield said bodywork factor.

11. The system of claim 6 wherein said adjustment factor includes an engine factor and further comprising:
an engine databank connected to said processor, said processor selectively accessing said engine databank for an engine value corresponding to said machine and combining said engine value and said engine data according to said predetermined algorithm to yield said engine factor.

12. The system of claim 7 wherein said adjustment factor includes an alignment factor and further comprising:
an alignment databank connected to said processor, said processor selectively accessing said alignment databank for an alignment value corresponding to said machine and combining said alignment value and said alignment data according to said predetermined algorithm to yield said alignment factor.

13. The system of claim 8 wherein said adjustment factor includes an undercarriage factor and further comprising:
an undercarriage databank connected to said processor, said processor selectively accessing said undercarriage databank for an undercarriage value and combining said undercarriage value and said undercarriage images according to said predetermined algorithm to yield said undercarriage factor.

14. A device for determining the repair cost of a vehicle from a remote location comprising:
a processor;
a repair databank containing a plurality of repair values, said databank being selectively accessed by said processor; and,
means for diagnosing the mechanical condition of said vehicle, said diagnosing means generating a plurality of repair requirements according to said mechanical condition and sending said plurality to said processor, said processor accessing said repair databank and combining said repair values and said plurality according to a predetermined algorithm to yield said repair cost for said vehicle.

15. The device of claim 14 wherein said device includes an enclosure having a floor and wherein said repair databank includes an alignment sub-bank, wherein said vehicle has a plurality of wheels, and wherein said diagnostic means is mounted within said enclosure and comprises:
a plurality of rollers recessed in said floor for determining camber and alignment of said wheels, each of said wheels resting on a corresponding roller when said machine is within said enclosure, each of said rollers being connected to said processor for transmitting alignment data on a corresponding wheel to said processor; and,
said processor selectively accessing said alignment sub-bank for an alignment value and combining said alignment data and alignment value to yield an alignment repair cost for said vehicle.

16. The device of claim 15 wherein said vehicle has an interior, wherein said repair databank includes an interior sub-bank, and wherein said diagnostic means further comprises:
a telescoping stand having a floor end and a camera end, said floor end being being movably mounted to said floor to allow for movement of said stand completely around said machine when said machine is within said enclosure; and,
a floor camera mounted to said camera end and connected to said processor for transmitting interior images of said machine to said processor, said processor selectively accessing said interior sub-bank for an interior value and combining said interior data and interior images to yield an interior repair cost for said vehicle.

17. The device of claim 16 wherein said repair databank includes a bodywork sub-bank, wherein said vehicle has a body, wherein said enclosure includes a ceiling, and wherein said diagnostic means further comprises:
an overhead camera movably attached to said ceiling for taking body images of said machine, said overhead camera being connected to said processor for sending said body images to said processor; and,
said processor selectively accessing said bodywork sub-bank for an bodywork value corresponding to said vehicle and combining said body images and said bodywork value to yield a body repair cost for said vehicle.

18. The device of claim 17 wherein said repair pair databank includes an engine sub-bank, wherein said vehicle has an engine, and further comprising:
an engine analyzer mounted within said enclosure and connected to said processor;
a microphone mounted within said enclosure and connected to said processor, said engine analyzer and said microphone, in combination, transmitting engine data to said processor when said engine is operating; and,
said processor selectively accessing said engine sub-bank for an engine value and combining said engine data and engine value to yield an engine repair cost for said vehicle.

19. The device of claim 16 wherein said repair databank includes an undercarriage sub-bank, wherein said vehicle has an undercarriage, and further comprising:
a hydraulic lift reciprocatingly mounted in said floor for raising said machine to spaced-apart position from said floor when said machine is resting on said lift; and,
said floor camera transmitting undercarriage images to said processor when said vehicle is in said spaced-apart position; and,
said processor selectively accessing said undercarriage sub-bank for an undercarriage value and combining said undercarriage data and said undercarriage value to yield an undercarriage repair cost for said vehicle.

20. A method for appraising the value of a vehicle which comprises the steps of:
(A) building a reference databank of published values for said vehicle;
(B) diagnosing the mechanical condition of said vehicle;
(C) generating a list of prioritized repair actions for said vehicle;
(D) establishing a maintenance databank having a plurality of adjustment factors, each adjustment factor corresponding to the cost of a respective repairs action for said vehicle;
(E) accessing said databank of published values to yield a baseline value for said vehicle;
(F) combining said repair actions and said adjustment factors to yield an overall repair cost for said vehicle; and,
(F) selectively adjusting said baseline value according to said overall repair cost to yield an appraisal value for said vehicle.
